(19) United States
(12) Patent Application Publication
(10) Pub. No.: US 2012/0223966 A1
(43) Pub. Date: Sep. 6, 2012

(54) TERMINAL TO PROVIDE AUGMENTED REALITY

(75) Inventor: Jun Sung LIM, Seoul (KR)

(73) Assignee: PANTECH CO., LTD., Seoul (KR)

(21) Appl. No.: 13/224,071

(22) Filed: Sep. 1, 2011

(30) Foreign Application Priority Data
Dec. 28, 2010 (KR) 10-2010-0136580

(51) Int. Cl. G09G 5/377

(52) U.S. Cl. 345/633

(57) ABSTRACT

A terminal that displays augmented reality, allows tag information of various recognized objects to be chosen and displayed in a more efficient manner. The terminal that displays augmented reality allows the terminal to enter into an augmented reality mode is executed, and provides location information about the terminal and the recognized objects, a category selection ability to select categories of tag information, and a tag information control layout for displaying the selected tag information and different stages on a display in a more efficient manner.

### CROSS-REFERENCE TO RELATED APPLICATION

This application claims priority from and the benefit under 35 U.S.C. §119(a) of Korean Patent Application No. 10-2010-0136580, filed on Dec. 28, 2010, which is incorporated by reference for all purposes as if fully set forth herein.

### BACKGROUND

1. Field

This disclosure relates to a terminal to provide augmented reality, and more particularly, to a terminal to provide augmented reality based on a category selected.

2. Discussion of the Background

In general, augmented reality is a technique for combining an image of the real world with a virtual world or information, with the combination shown on a display. In order to combine the virtual world/information with the real-world image, using the augmented reality technique, either markers having patterns set in advance are used, or markers are not used.

Particularly, if markers are not used, augmented reality services may be provided using current location information and azimuth information of a device, and/or by recognizing objects in an image acquired through a camera, and the like.

In situations where a number of pieces of tag information are displayed on a preview image, pieces of tagged information may overlap due to a small display. Accordingly, a user may not easily view the tag information associated with the augmented reality, and it may be difficult for the user to distinguish between the various pieces of tag information on a display due to the overlap.

### SUMMARY

This disclosure provides a terminal to provide augmented reality capable of organizing tag information used in association with the augmented reality, and to provide different stages to view the augmented reality.

Additional features of the invention will be set forth in the description which follows, and in part will be apparent from the description, or may be learned by practice of the invention.

An exemplary embodiment provides a terminal to display augmented reality on a display, the terminal including: an image processing unit to add a plurality of tag information to a real-time image; and a layout providing unit to subdivide the display into different images, and to control the plurality of the tag information to be displayed based on an image currently being displayed on the display.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram schematically illustrating a terminal according to an exemplary embodiment.

FIGS. 2 to 13 are example displays according to exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments will now be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

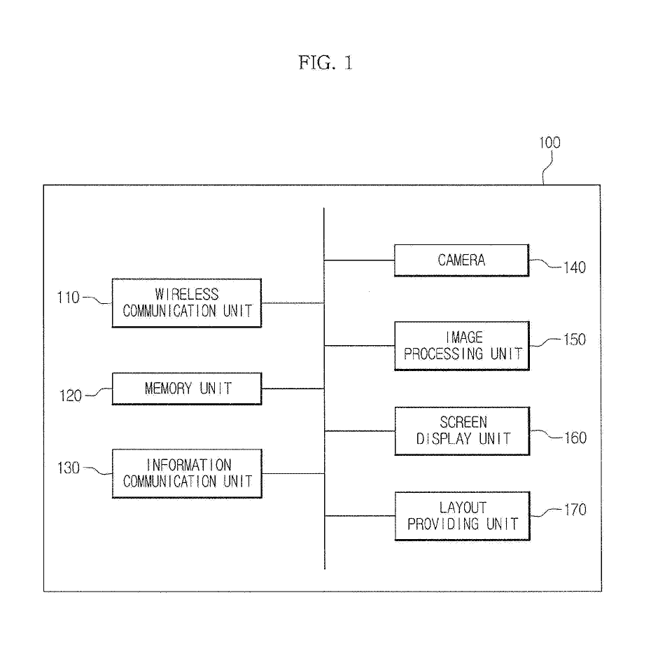

FIG. 1 is a diagram schematically illustrating a terminal according to an exemplary embodiment.

Referring to FIG. 1, a terminal 100 may include a wireless communication unit 110, a memory unit 120, an information communication unit 130, a camera 140, an image processing unit 150, a display unit 160 and a layout providing unit 170.

The wireless communication unit 110 may be connected to a server for providing augmented reality (not shown) through a wireless communication network if an augmented reality mode is executed.

The information receiving unit 130 receives one or more pieces of tag information 171 from the server (not shown), and transmits the received tag information 171 to the image processing unit 150.

The information receiving unit 130 may receive the tag information 171 recognized by the server for providing augmented reality (not shown) on the basis of current location information and azimuth information of the terminal 100, which is transmitted to the server (not shown), or receives the tag information 171 related to objects recognized by the server (not shown) on the basis of an image acquired through a camera 140. The image may be transmitted to the server (not shown), and the image may contain extracted feature points. However, aspects are not limited thereto such that the memory unit 120 may store other information, such as data, programs, operating systems, applications, etc.

The memory unit 120 stores the tag information 171 received from the server (not shown).

The image processing unit 150 adds the tag information 171 to a real-time image acquired from the camera 140 to be displayed on a display unit 160. The real-time image may be, for example, a preview image, cached image, and the like, and may be received from another unit other than the camera 140, such as an external camera.

A layout providing unit 170 subdivides a layout, to enable a user of the terminal to control the tag information 171 into various categories, thereby allowing for greater control of an augmented reality view on a display.

The layout providing unit 170 may subdivide the layout into various stages/categories. For example, three stages may include a preview image stage, an enlarged image stage, and a detailed tag information image stage.

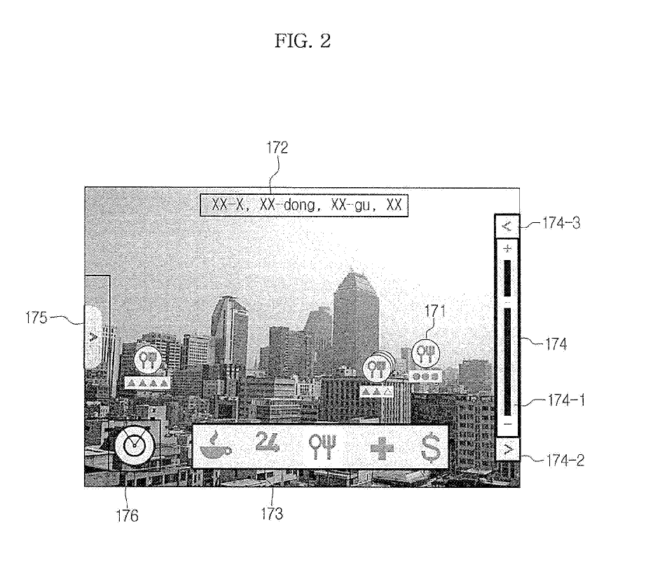

FIGS. 2 to 13 are example displays according to exemplary embodiments.

If the augmented reality mode is executed, a preview image may be displayed. If the augmented reality service is based on location, the layout providing unit 170 displays a preview image stage, which may include a location notification layout 172, a category selection layout 173, a tag information control layout 174, a tag information list layout 175, and an azimuth notification layout 176. An example is illustrated in FIG. 2.

Tag information 171, as shown in FIG. 2, is one or more pieces of tag information 171 received in the terminal 100 from the server (not shown) based on current location information of the terminal 100, and may represent information, such as the name, and/or category, and the like, of an object.

The tag information 171 may be sequentially displayed so that the tag information 171 that is closest to the terminal 100 is located in the foreground, or if the tag information 171 pertains to persons, the tag information 171 may be sequentially displayed so that the tag information 171 registered last is located in the foreground. For example, one or more pieces of the tag information 171 in a specific or same direction may be displayed sequentially according to a distance from the terminal 100.

The location notification layout 172 displays the current location information of the terminal 100, and may display information, such as an address, latitude, longitude, or the like. Specifically, if the location notification layout 172 is touched or activated, the terminal 100 may toggle the various pieces of information, such as the current address, the latitude and the longitude.

The category selection layout 173 provides selectable categories, and activates the terminal 100 to display tag information 171 based on a selected category. The category selection layout 173 contains a list including various categories (for example, Korean restaurants, Japanese restaurants, fast-food restaurants, coffee shops, theaters, banks, hospitals, pharmacies, convenience stores/marts, subways, men, women, friends, SNS users, and the like) that may be selected, so as to filter the tag information 171 to be displayed in the terminal 100. If a category is selected, objects matching the selected category may be searched and the results of the search may be displayed by the terminal 100.

For example, a category may be selected from among the categories in the category information list provided through the category selection layout 173, to show the tag information 171 of the category to be searched.

The category selected may be distinguished from the other categories with a different color or may be provided with a check mark. In addition, in a case where there are many categories, so that not all of the category information may be displayable on a single display, the category information list may be moved to the left and to the right using a touching operation on the terminal 100, such as a flicking, dragging or touching operation, so as to show and scroll through the various category information available. The categories may be subdivided.

The tag information control layout 174 allows for the adjustment of tag information 171 displayed on the terminal 100. The tag information 174 may have an adjustment key 174-1 to enlarge or reduce the preview image.

Accordingly, the preview image may be enlarged or reduced by adjusting the adjustment key 174-1.

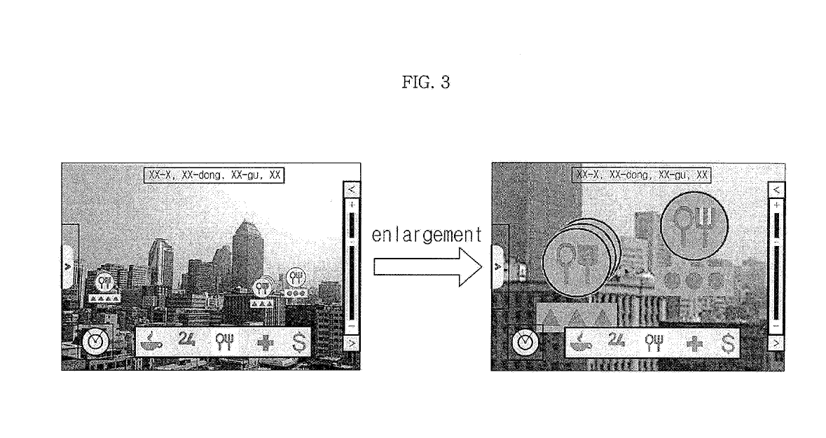

Referring to FIG. 3, if the preview image is enlarged the adjustment key 174-1 is adjusted, and the tag information 171 is enlarged, so that the overlapped pieces of the tag information 171 may be more easily viewed.

The tag information control layout 174 may also include a next key (>) 174-2 to go to the next stage and a back key (<) 174-3 to go back to the previous stage. The back key (<) 174-3 may not be activated in the preview image.

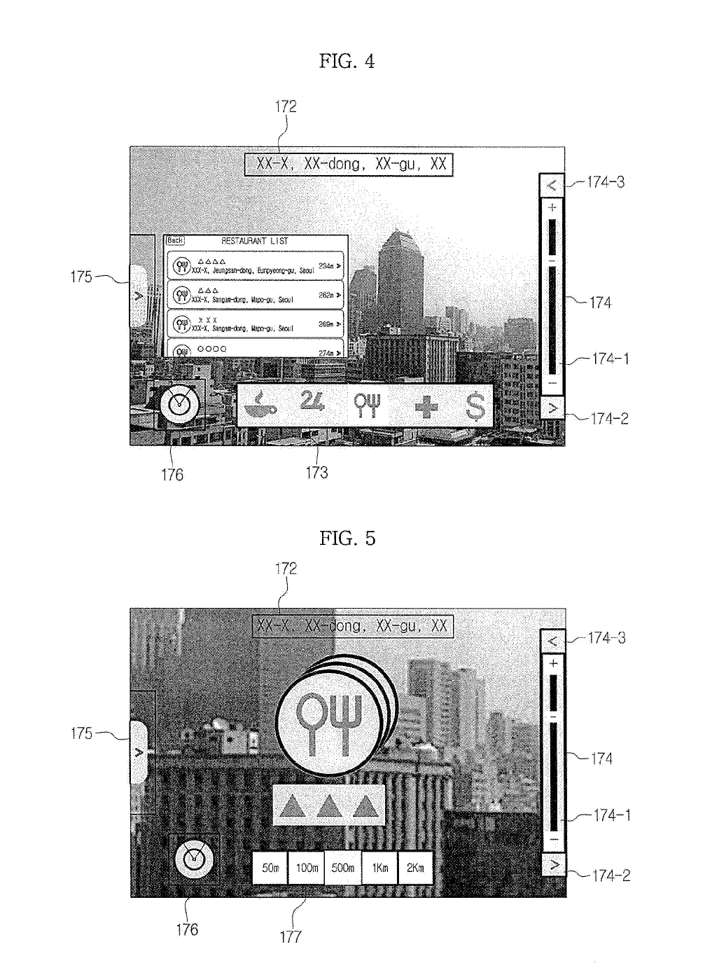

Referring to FIG. 4, the tag information list layout 175 may include a tag information list 401, which contains further information about a selected category or tag information 171.

The tag information list layout 175 hides the tag information list 401 and provides the tag information list 401 if activated. An example of the tag information list 401 being displayed is shown in FIG. 4.

The azimuth notification layout 176 indicates azimuth information, which may be information indicating a direction of a terminal 100.

Referring to FIG. 5, if a particular region is designated (for example, a region where several tag information 171 overlap) by dragging a preview image, as illustrated in FIG. 2 or on the enlarged preview image illustrated in FIG. 3, the region designated is provided as an enlarged image.

As described above, if the preview image is switched to the enlarged image, the tag information control layout 174 may allow various pieces of tag information 171, that may be overlapped in the enlarged image view, to be sequentially selected using the adjustment key 174-1.

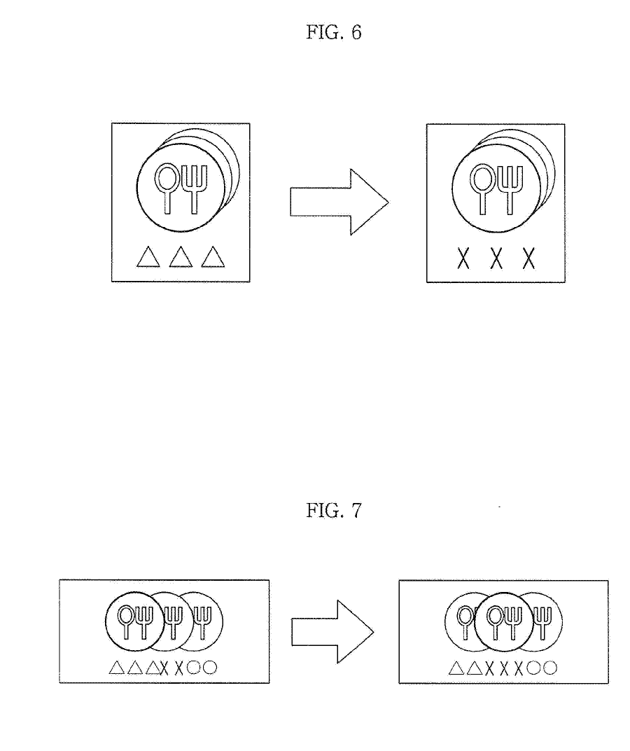

Referring to FIG. 6, with the use of the adjustment key 174-1, the foremost tag information 171 may be readjusted to be displayed in the background, or the backmost tag information 171 may be readjusted to be displayed in the foreground, i.e., the order of the tag information 171 may be adjusted or changed.

For example, if the tag information 171 is about items (such as an item that is detected from an image), the order of display of the various tag information 171 associated with the items that are overlapped may be set by a distance from the terminal 100. Thus, if the adjustment key 174-1 is moved to a higher level, the tag information 171 closest to the terminal 100 may be displayed in a foreground, and when the adjustment key 174-1 is moved to a lower level, the tag information 171 farthest from the terminal 100 may be displayed in a foreground.

In another example, if a display of a terminal 100 displays tag information 171 pertaining to people, entered manually by a previous user, the order of display may correspond to a registration time of the tag information 171. Thus, if the adjustment key 174-1 is moved to a higher level, the tag information 171 registered most recently may be displayed in a foreground, and if the adjustment key 174-1 is moved to a lower level, the tag information 171 registered earliest may be displayed at a foreground.

Referring to FIG. 7, alternatively or in addition to, the various pieces of tag information 171 that are overlapped may be arranged based on the shape, and may be selected sequentially clockwise or counterclockwise by the adjustment key 174-1.

Specifically, if pieces of tag information 171 are overlapped densely in the front and back direction, an adjustment of adjustment key 174-1 may cause the foremost tag information 171 to be sent to the background, or the backmost tag information 171 to be sent to the foreground. However, if tag information 171 is overlapped in the left and right direction as illustrated in FIG. 7, as the adjustment key 174-1 is adjusted, the pieces of tag information 171 may be selected sequentially clockwise or counterclockwise. Referring again to FIG. 7, once a tag information 171 is selected (as the middle one is), that tag information 171 may be displayed in the foreground amongst the overlapping various tag information 171.

Further, the tag information 171 that are overlapped are sequentially selected by adjusting the adjustment key 174-1 included in the tag information control layout 174. However, the foremost tag information 171 may also be moved forward, backward, leftward and rightward, so that the backmost tag information 171 may be displayed in the foreground using a flicking, dragging or touching operation.

If next key (>) 174-2 is pressed to go to the next stage, thus switching the terminal 100 preview image to an enlarged image, the tag information 171 displayed at the foreground is selected, thereby displaying a detailed tag information display (not shown) about the selected tag information 171, and the back key (<) 174-3 is pressed, the preview image is once again displayed.

Referring again to FIG. 5, if the preview image is switched to the enlarged image, the layout providing unit 170 may display a distance information layout 177. The distance information layout 177 represents how far away the tag information 171 displayed at the foreground is from the terminal 100.

As described above, if the preview image is switched to the enlarged image, the display unit 160 may not display a real-time image acquired through the camera 140, but a captured still image based on the enlarged view. Thus, tag information 171 found in the region corresponding to the enlarged image may be displayed. Accordingly, after the preview image is switched to the enlarged image, even if the terminal 100 is moved, the still image corresponding to the enlarged image may be maintained on the display unit 160.

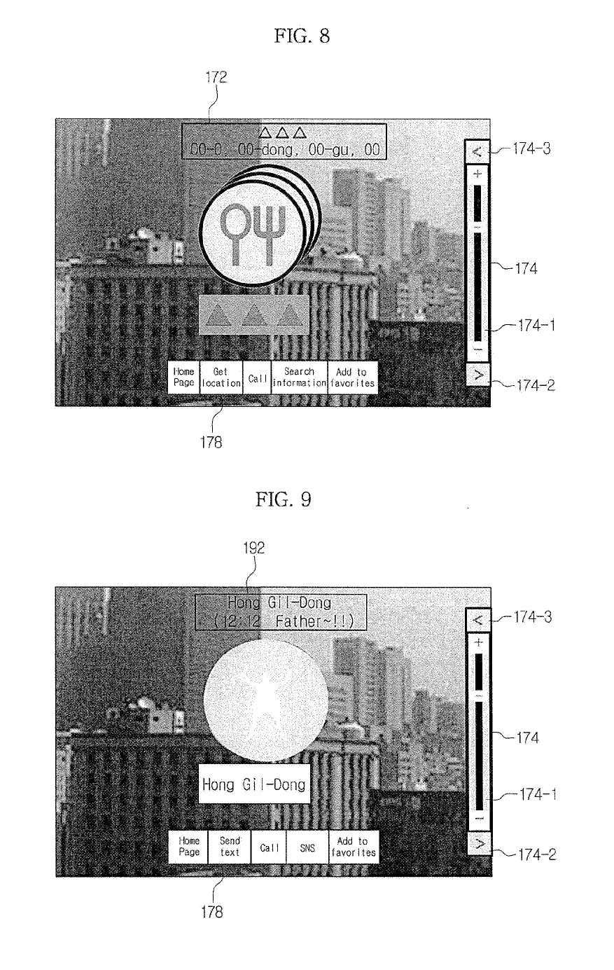

Referring to FIG. 8, if the foremost tag information 171 on the enlarged image is selected, detailed information about the tag information 171 by the terminal user is provided through a detailed tag information display.

Thus, if the enlarged image is switched to the detailed tag information display, the layout providing unit 170 provides a detailed tag information layout 178.

The detailed tag information layout 178 includes categories that may be selected to obtain the detailed information about the tag information 171.

Referring to FIG. 8, the detailed tag information layout 178 may include operations, such as go to homepage, get location, call, search information, add to favorite, send e-mail, and the like.

Accordingly, the terminal 100 may perform a desired operation if one of the operations of the detailed tag information layout 178 is selected. For example, if the get location option is selected, a map displaying the location of the current object is provided, and if the search information option is selected, the terminal 100 may connect to a portal site to search for the information about the corresponding object.

Referring to FIG. 9, if the selected tag information 171 is related to a person, the detailed tag information layout 178 provides operations, such as go to homepage, send text, call, SNS (social network service), add to favorites, mini homepage, send e-mail, messenger, and the like.

Accordingly, the terminal 100 may perform an operation corresponding to a selected operation of the detailed tag information layout 178. For example, if the send text option is chosen, a prompt for writing a text message is provided, and if the call option is selected, settings for voice calling are executed.

The detailed tag information layout 178 may be configured to selectively provide the operations, such as go to homepage, get location, send text, call, SNS, information search, add to favorites, mini homepage, send e-mail, and messenger depending on whether the object corresponding to the tag information 171 is an item or a person. If the operations are numerous and thus do not fit in a single view of the tag information layout 178, the detailed tag information layout 178 may be moved to the left or to the right using a flicking, dragging or touching operation so as to provide the other operations that are not displayed on the current display.

The layout providing unit 170 may provide the name and address information of the object selected by the via the location notification layout 172. If the object is an item, the name (for example, restaurant name, public office name, hospital name, pharmacy name, and the like) of the object and the address information of the object may be displayed. If the object is a person, information such as a name or nickname, messages from the person, and time at which the corresponding message is registered, or the like may be displayed.

On the detailed tag information display, the layout providing unit 170 may be configured to not activate the adjustment key 174-1 and the next key (>) 174-2 to go to the next stage in the tag information control layout 174, but only activate the back key (<) 174-3 so as to be switched to the enlarged image which is the previous stage, thereby allowing another tag information 171 to be selected.

On the detailed tag information display, the layout providing unit 170 may be configured to not display the tag information list layout 175 and the azimuth notification layout 176, which are provided on the preview image and the enlarged image.

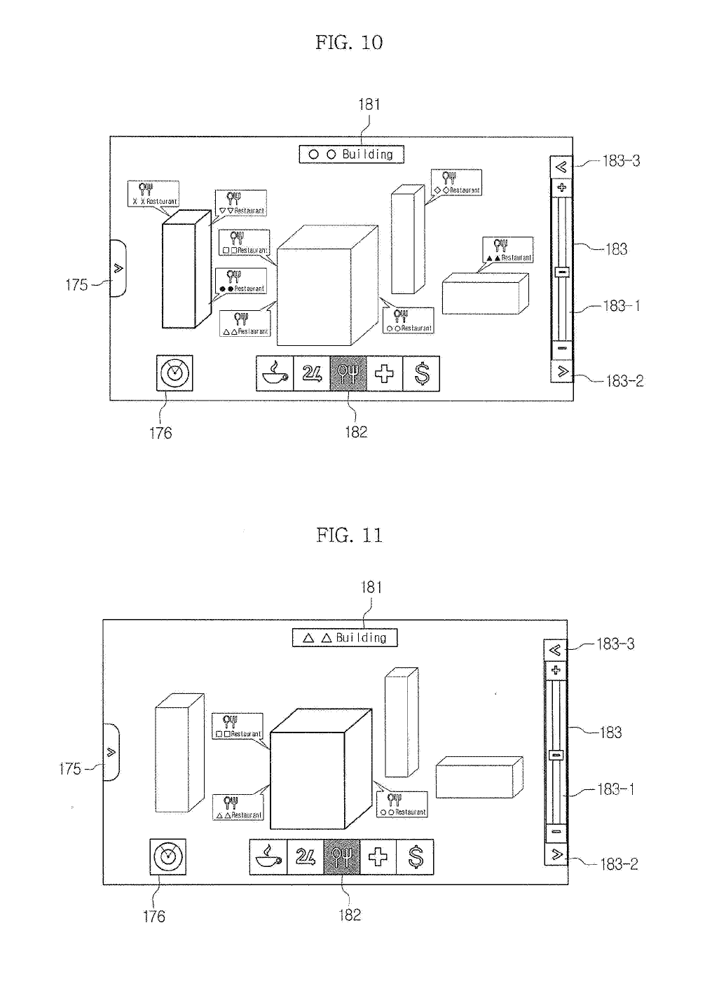

Referring to FIG. 10, if augmented reality service is provided based on object recognition, in the preview image stage, the layout providing unit 170 may display an object notification layout 181, a category selection layout 182, a tag information control layout 183, the tag information list layout 175, and the azimuth notification layout 176. The tag information list layout 175 and the azimuth notification layout 176 may have the same or similar configurations and operations as an augmented reality service based on the location being provided, and thus are denoted by the same reference numerals, and detailed description thereof will be omitted.

Referring to FIG. 10, the object notification layout 181 provides basic information on the recognized object. If the recognized object is a building, it displays the name of the building.

The category selection layout 182 provides selectable categories to display tag information 171 received from the server (not shown) in relation to the object recognized from an image acquired through the camera, based on a selected category. The category selection layout 182 provides a category information list including categories, such as, Korean restaurants, Japanese restaurants, fast-food restaurants, coffee shops, theaters, banks, hospitals, pharmacies, convenience stores/marts, subways, men, women, friend, SNS users, and the like, that may be selected, shown, and searched for. If a category is selected, objects matching the selected category may be searched and the results of the search may be displayed by the terminal 100.

For example, a desired category selected in the category information list of the category selection layout 182, to show tag information 171 corresponding to the desired category.

The tag information control layout 183 provides an adjustment key 183-1 to enlarge or reduce a preview image or reduce the enlarged preview image. The adjustment key 183-1 may enlarge or reduce a preview image and/or enlarge or reduce an enlarged image.

In addition, the tag information control layout 183 may include a next key (>) 183-2 to go to the next stage and a back key (<) 183-3 to go back to the previous stage. On the preview image, the back key (<) 183-3 is not activated.

As described above, if the augmented reality service based on the object recognition is provided, if the number of recognized objects is one or more, as illustrated in FIG. 10, tag information 171 about the one or more recognized objects may be displayed, or as illustrated in FIG. 11, objects associated with the tag information 171 corresponding to the selected categories may be displayed.

Here, the layout providing unit 170 allows the recognized objects to be selected using the adjustment key 183-1 or allows an object to be designated and selected.

As described above, if one of the recognized objects is selected, as illustrated in FIG. 11, the object notification layout 181 provides basic information on the selected object using the adjustment key 183-1 of the tag information control layout 183.

In addition, the category selection layout 182 is configured to provides selectable categories and display one or more pieces of tag information 171 received from the server (not shown) in relation to the selected object using the adjustment key 183-1 of the tag information control layout 183.

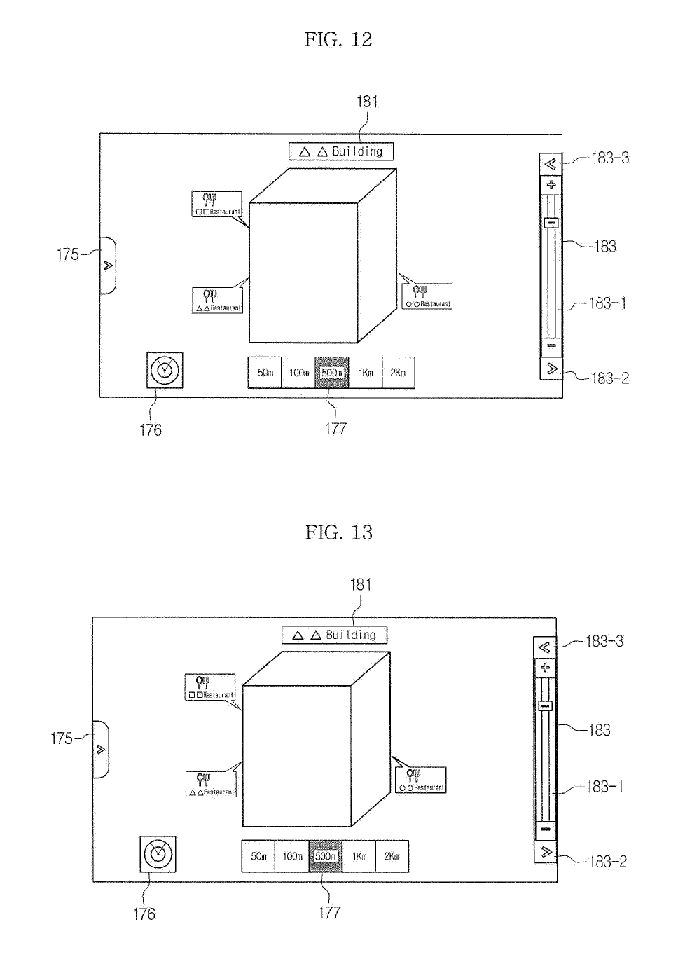

Referring to FIG. 12, if a particular region is designated (for example, a region where the recognized object is displayed, or a region where an object selected from among one or more recognized objects is displayed) on the preview image as illustrated in FIG. 10 or FIG. 11, by a dragging, touch, or flicking operation, or the like, the region designated by the terminal user is provided as an enlarged image.

As described above, if the preview image is switched to the enlarged image once a region has been designated, the tag information control layout 183 may allow one or more pieces of tag information 171 displayed in the region designated to be selected using the adjustment key 183-1.

Referring to FIG. 13, if the adjustment key 183-1 is activated, the one or more pieces of tag information 171 are selected sequentially clockwise or counterclockwise.

If the preview image is switched to the enlarged image, the layout providing unit 170 may display the distance information layout 177. The distance information layout 177 represents how far the tag information 171 that is selected using the adjustment key 183-1 is from the location of the terminal 100.

If the tag information 171 is selected using the adjustment key 183-1 on the enlarged image, as illustrated in FIG. 12, detailed information about the tag information 171 selected is provided on a detailed tag information display (not shown). If the enlarged image is switched to the detailed tag information display the tag information 171 is selected, the layout providing unit 170 provides the detailed tag information layout 178. The detailed tag information layout 178 may be the same or similar in configuration and operation as those of the detailed tag information layout 178 where the augmented reality service is based on the location information, so the detailed description thereof will be omitted.

According to the disclosed terminal for providing augmented reality, the tag information 171 based on a desired category or situation may be accessed more readily.

In addition, because the layout is subdivided various stages, more information may be provided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to display augmented reality on a display, the terminal comprising:
an image processing unit to add a plurality of tag information to a real-time image; and
a layout providing unit to subdivide the display into different images, and to control the plurality of the tag information to be displayed based on an image currently being displayed on the display.

2. The terminal according to claim 1, wherein the layout providing unit comprises:
a location notification layout unit to provide location information of the terminal;
a category selection layout unit to provide selectable categories based on the current location information; and
a tag information control layout unit to display the plurality of tag information corresponding to the category.

3. The terminal according to claim 1, wherein the layout providing unit comprises:
an object notification layout unit to provide information of a plurality of recognized objects;
a category selection layout to provide selectable categories; and
a tag information control layout unit to display a plurality of recognized objects corresponding to the selected category, and the plurality of tag information that corresponds to the display plurality of recognized objects.

4. The terminal according to claim 3, wherein the tag information control layout unit allows the plurality of recognized objects to be selected sequentially, and
the object notification layout unit provides information on a selected recognized object.

5. The terminal according to claim 2, further comprises an azimuth notification layout to provide azimuth information of the terminal.

6. The terminal according to claim 3, further comprises an azimuth notification layout to provide azimuth information of the terminal.

7. The terminal according to claim 2, further comprising an adjustment key to resize a preview image, and to switch the display to an enlarged image,
wherein the enlarged image is a zoomed-in view of the preview image, and
the plurality of tag information that exists in both the enlarged image and the preview image is added to an image displayed on the enlarged image.

8. The terminal according to claim 3, further comprises an adjustment key to resize a preview image, and to switch the display to an enlarged image,
wherein the enlarged image is a zoomed-in view of the preview image, and
the plurality of tag information that exists in both the enlarged image and the preview image is added to an image displayed on the enlarged image.

9. The terminal according to claim 1, further comprises a next key to activate another image of the different images.

10. The terminal according to claim 7, wherein adjustment key is provided to select an order of display of the plurality of the tag information if the plurality of tag information overlap with each other.

11. The terminal according to claim 8, wherein adjustment key is provided to select an order of display of the plurality of the tag information if the plurality of tag information overlaps with each other.

12. The terminal according to claim 7, wherein the adjustment key provides selectable manipulation of the plurality of the tag information, in a sequential and clockwise/counter-clockwise manner.

13. The terminal according to claim 8, wherein the adjustment key provides selectable manipulation of the plurality of the tag information, in a sequential and clockwise/counter-clockwise manner.

14. The terminal according to claim 2, further comprising a distance information layout unit to display a distance of a selected object from the terminal.

15. The terminal according to claim 3, further comprising a distance information layout unit to display a distance of a selected object from the terminal.

16. The terminal according to claim 2, wherein, if one of the plurality of the tag information is selected, a detailed tag information image displays detailed tag information of the selected one of the plurality of the tag information.

17. The terminal according to claim 3, wherein, if one of the plurality of the tag information is selected, a detailed tag information image displays detailed tag information of the selected one of the plurality of the tag information.

18. The terminal according to claim 17, wherein, if the selected one of the plurality of the tag information pertains to an item, the terminal provides an option of selecting one of the following operations: go to homepage, get location, call, search information, add to favorites, and send e-mail.

19. The terminal according to claim 18, wherein, if the selected one of the plurality of the tag information pertains to a person, the terminal provides an option of selecting one of the following operations: go to homepage, send text, call, SNS (social network service), add to favorites, mini homepage, send e-mail, and messenger.

20. The terminal according to claim 1, wherein an order of display of the plurality of tag information, if the plurality of tag information overlap each other, is based on a distance between the terminal and an object corresponding to each of the plurality of tag information.

21. The terminal according to claim 1, wherein an order of display of the plurality of tag information, if the plurality of tag information overlap each other, is based on a registration time of each of the plurality of tag information.
